(19) United States
(12) Patent Application Publication
(10) Pub. No.: US 2018/0052004 A1
(43) Pub. Date: Feb. 22, 2018

(54) WEARABLE NAVIGATION INTERFACE SYSTEM

(71) Applicant: Lab Brothers, LLC, Marietta, GA (US)

(72) Inventor: Steven Friedlander, Escondido, CA (US)

(73) Assignee: Lab Brothers, LLC, Marietta, GA (US)

(21) Appl. No.: 15/636,478

(22) Filed: Jun. 28, 2017

Related U.S. Application Data
(60) Provisional application No. 62/355,815, filed on Jun. 28, 2016.

(51) Int. Cl. G01C 21/36; G06F 3/01; G01C 21/20; G01C 23/00; G01C 17/00; A41D 19/00

(52) U.S. Cl. CPC G01C 21/3632; G06F 3/014; G01C 21/20; G01C 23/00; H04W 4/008; G01C 17/00; A41D 19/0024; A41D 19/002; A41D 19/001; G01C 21/3664

(57) ABSTRACT

A wearable navigation interface device includes an LED display. The device establishes wireless communication with a navigation control device that has navigation software installed thereon. The device determines a current geographic location and route to a desired destination, the route including a plurality of turning points. Navigation information is received from the navigation control device and, based on such navigation information, first provides a notification light pattern on the LED display, and, thereafter, provides the direction and distance in which the user should go until reaching the next turning point along the route using a directional light pattern on the LED display arrangement. The wearable navigation device is preferably included on the back side of a rider's glove. Contacts included in the fingertips of the glove enable the rider to select functions and information to be displayed on the device.

### CROSS-REFERENCE TO RELATED APPLICATIONS

This patent application claims priority benefit under 35 U.S.C. §119(e) to U.S. Prov. Pat. Appl. No. 62/355,815, entitled “Navigation Motorcycle Glove,” filed Jun. 28, 2016, which is incorporated herein by reference in its entirety.

### FIELD OF THE INVENTION

The present invention relates generally to personal navigation devices and, more particularly, to methods, systems, and devices that synchronize with a GPS mapping system and that provide navigation prompts and information by means of an easy-to-use and easy-to-view interface integrated into a wearable glove or similar garment item usable by a motorcyclist or cyclist while riding.

### BACKGROUND OF THE INVENTION

Based on survey and market data available from 2009, there were over 11 million motorcycles in use by over 26 million riders in the United States. That number has grown each year thereafter and is expected to continue to rise in the future.

Although many GPS and mapping applications have been developed for use on mobile devices and for mounting or installation in automobiles to help drivers navigate the roads, such solutions do not work as well for bike riders, 4-wheelers, or motorcyclists. Current mapping applications on mobile devices for use by vehicle drivers include Google Maps and Waze, to mention a few. In addition, most automobiles now either have navigation mapping systems built into the vehicle dashboard or make use of a portable navigation system, such as those offered by Garmin and similar manufacturers. Almost all of these solutions use a display screen that illustrates a scalable map and that shows the location, using GPS data, of the device/vehicle on that map. Most of these solutions also enable the user to select a destination and then have the map show or audibilize route instructions as the device/vehicle travels from a starting or current location to the selected destination.

Such solutions, however, are less than ideal for motorcyclists, bikers, cyclists, 4-wheel drivers, and other drivers of similar vehicles in which the driver is typically exposed to the environment or that typically require the driver to use both hands to steer the vehicle using handlebars. Because safe handling of a motorcycle and similar vehicles generally requires use of both hands and since most motorcyclists wear gloves for warmth or grip, active visual reliance upon an navigation application running on a mobile device is not practical. Although high end motorcycles may offer a small, built-in navigation system/display and even though existing portable navigation systems can be mounted onto the dashboard or handlebars, such systems tend to be expensive and harder to view and use for a motorcyclist while riding as compared to an automobile driver or passenger.

Typically, motorcyclists have had to adapt to the current lack of solutions in a number of different ways. For example, many motorcyclists rely on memorization. They study a map before they go somewhere and memorize the route. If they forget or get lost, they then have to pull over and re-consult the navigation application on their mobile device. Alternatively, some motorcyclist put their mobile device in a tank bag that has see-through plastic. Although the tank bag keeps the mobile device safe from weather and being dropped, such a bag is not aesthetically pleasing and still requires the motorcyclist to view and interact with a display screen, while riding, and while dealing with sun glare on the screen or on the plastic cover. In another alternative, a biker can merely follow someone else, in another vehicle or on another bike, who knows the route.

Thus, there remains a need in the market for a portable navigation device and system designed specifically for use by motorcyclists and, particularly, for a portable navigation device that is wearable and easy to view and use by a motorcyclist while riding.

### SUMMARY OF THE INVENTION

The present invention relates generally to personal navigation devices and, more particularly, to methods, systems, and devices that synchronize with a GPS mapping system. In a preferred embodiment, the methods, systems, and devices provide navigation prompts and information by means of an easy-to-use and easy-to-view non-display screen interface that is integrated into the back of a wearable glove or similar garment item and that is usable in a safe manner by a motorcyclist while riding.

Preferably, the motorcyclist's glove disclosed and described herein includes a processor, a wireless communication component, an LED arrangement, and software installed in memory thereon to enable the glove to establish a wireless communication with a navigation control device, such as a mobile phone having a suitable navigation application installed thereon whereby navigation prompts and information can be displayed to the motorcyclist while riding in a manner that is safe and easy to use.

Preferably, the motorcycle glove disclosed and described herein includes a Bluetooth LE module that is insertable within a pocket formed on the back of the glove. The LE module syncs with a navigation system, such as Google Maps, Waze, or the like, installed and running on the rider's phone or mobile device. The module has LED lights that will show the rider which way to turn based on navigation information provided by the synched navigation app.

Putting the LED arrangement on the back of a glove allows a motorcyclist to use and view the navigation prompts and information while riding and without requiring the user to remove his grip on the handlebars. A watch or other garment or accessory does not provide such ease of use since, for example, a watch requires the user to twist his wrist to view the display or pull up his jacket sleeve.

Preferably, the pocket on the back of the glove is accessible to enable the LED arrangement to be inserted or removed, if necessary. The pocket preferably has one or more see-through windows to enable the entire LED arrangement to be visible therethrough. The LED arrangement can be in any suitable form, such as a circle of LEDs, a row of LEDs, a grid of LEDs, or different combinations of the above.

Electronic switches are preferably integrated into the finger tip and thumb tip portions of the glove to enable the user to switch the navigation system on and off and to switch or toggle between different navigation functions by touching one or more selected fingertips to the thumb tip without requiring the user to remove his glove hand from the handlebars while riding. Preferably, conductive thread having a clip attachment would be sewn or glued in the glove pocket to hold the navigation device and to make contact with conductive threads that extend to each fingertip of the glove.

Providing a notification pattern or visual cue on the LED arrangement to get the attention of the rider before providing navigation prompts or information minimizes distractions and unnecessary duplication of views toward the LED arrangement and reduces the risk that important information is missed each time it is sent to the glove.

Having discrete light patterns that indicate turn directions, proximity to the next navigation event, compass information, altitude, and other navigation information allows a user to obtain necessary or desired navigation information without having to view an actual display screen or map while driving and without having to pull over and access the user's mobile device. Such light patterns are preferably pre-set by default but can also be customized by the user, if desired. Such animation light patterns make navigations direction more clear and easy to determine with less distraction to the rider.

For example, the LED arrangement preferably includes light patterns to indicate the next navigation event and turn directions (e.g., continue straight, veer right or left, turn right or left, or make a U-turn, etc.). In addition, the LED arrangement preferably includes light patterns that provide distance information to the next navigation event. For example, the number of LEDs that light up when distance information is being provided can indicate distances to the next navigation event. Such distances can be provided on a linear scale (e.g., each LED indicating 0.5 miles) or on an exponential scale (e.g., 1-2 LEDs indicating a range under a few hundred feet while the maximum number of LEDs can indicate a range in excess of X number of miles). Alternatively (or in combination with the number of LEDs that light up), flashing lights of different speeds or rates or in different, selected light patterns can be used to indicate the proximity to the next navigation event. For example, the LEDs can begin to blink faster and faster, until they remain in an “on” state, as the rider approaches the next navigation event that requires an action. In addition, different colored lights can be used to provide different information. For example, green lights could be used to indicate that the rider is on the correct route, yellow lights could indicate that a navigation even is coming up, and red lights could indicate that the navigation event has arrived or been passed. But, again, the options for how colors, light brightness, blinking or flashing effects, etc. are used are infinite and, preferably, can be customized by the user based on the user's preferences.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIG. 1 is a diagram illustrating a high level view of the navigation system described herein;

FIG. 2 is a close up view of the back side of a wearable glove and navigation display component for use with the navigation system shown in FIG. 1;

FIG. 3 is a close up view of the palm side of the wearable glove of FIG. 2 and fingertip switches useful for selecting functions associated with the navigation system of FIG. 1;

FIG. 4 illustrates an exemplary navigation display component for use with the wearable glove of FIGS. 2 and 3; and

FIGS. 5-7 illustrate alternative navigation display components for use with the wearable glove of FIGS. 2 and 3.

### DETAILED DESCRIPTION OF PREFERRED EMBODIMENTS

The present invention relates generally to personal navigation devices and, more particularly, to methods, systems, and devices that synchronize with a GPS mapping system. In a preferred embodiment, the methods, systems, and devices provide navigation prompts and information by means of an easy-to-use and easy-to-view non-display screen interface that is integrated into the back of a wearable glove or similar garment item and that is usable in a safe manner by a motorcyclist while riding.

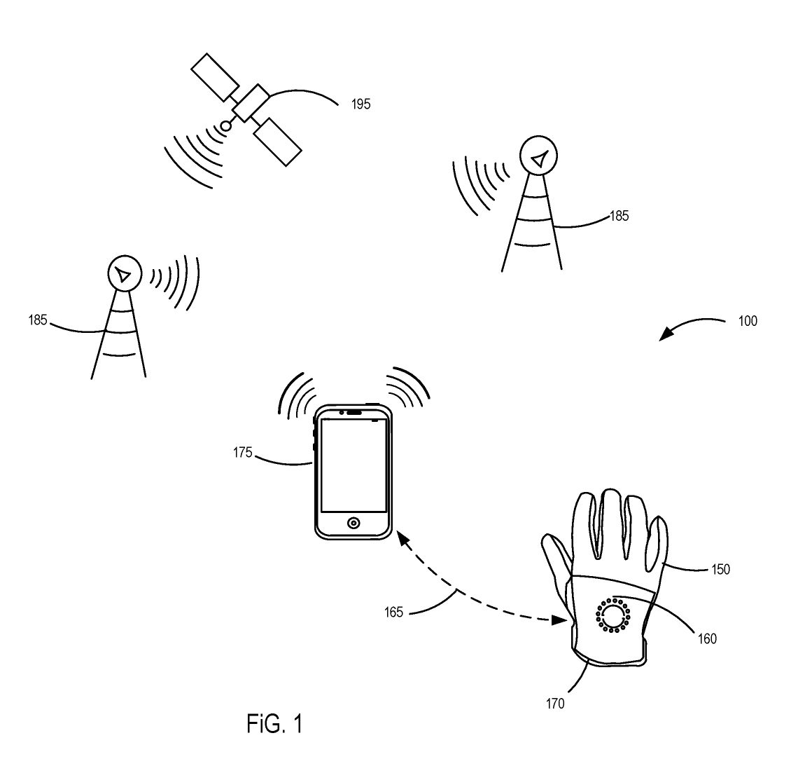

Turning now to FIG. 1, a preferred navigation system 100 includes a wearable navigation garment, such as a glove 150, as will be described in greater detail hereinafter, that is usable by a rider of a motorcycle or other vehicle (not shown). The wearable navigation glove 150 includes a navigation display component 160 integrated into the back side of the glove 150 or insertable into a see-through pocket 170 positioned on the back side of the glove 150. The navigation display component 160 preferably includes easy-to-read lights/LEDs or similar programmable and intuitive navigation prompts, rather than a conventional mobile device screen or map display. Having navigation prompts and information provided by LEDs on the back side of the rider's hand or glove is much easier to use and view by the rider while riding as compared to trying to read a conventional mobile device display screen or map interface mounted on the vehicle dashboard or held in the rider's hand while actively trying to ride.

Preferably, the navigation display component 160 includes a computer processor, an LED or light arrangement, a low voltage power supply, such as a battery, navigation prompting software installed in memory and controlled by the computer processor, and a wireless communication component, all of which will be described in greater detail hereinafter. The navigation prompting software on the glove establishes and uses a wireless or Bluetooth communication channel 165 to communicate and synchronize with a navigation control device 175, such as a mobile phone of the rider of a vehicle. Preferably, the navigation control device 175 includes a suitable navigation software application installed thereon. The navigation software application can be conventional, such as Google Maps, Waze, or other known navigation software, or it can be a customized application designed for use specifically with the navigation display component 160. The navigation control device 175 preferably includes conventional mobile communication components and global positioning system (GPS) components for communication with cellular towers 185 and GPS satellites 195 so that the navigation control device 175 can accurately determine its current geographic location and make use of the mapping functions provided by the navigation software.

Preferably, using such GPS information, the navigation software installed on the navigation control device 175 is used to identify the current location of the navigation control device 175 and to map the route from the current location to the desired destination or end location to which the user wants to reach. Instead of using the conventional map display of the navigation software on the display screen of the navigation control device 175, relevant information regarding the current user's location, such as compass/directional information, altitude, and the like, and relevant route information needed by the rider to determine the current direction the rider should be travelling and the next turning or change point (direction and distance to that change point) at which the rider will need to change direction or road, is transmitted from the navigation control device 175 to the navigation display component 160. Suitable data requests, such as may be obtained using API calls or commands, may be made by the navigation prompting software associated with the navigation display component 160 to the navigation software installed on the navigation control device 175. As will be appreciated by those of skill in the art, all of the navigation prompting software may be installed and residing in memory of the navigation display component 160 or the navigation prompting software can be installed as two separate components, one in memory of the navigation display component 160 and one installed on the navigation control device 175, to facilitate obtaining and transmission of the relevant (and limited) information needed from the navigation software by the navigation display component 160.

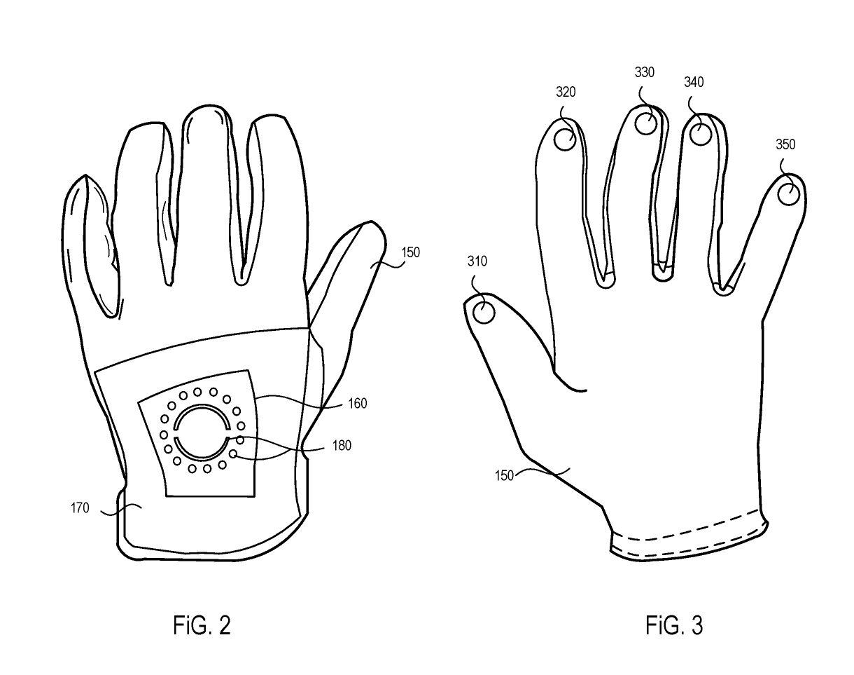

FIG. 2 illustrates a close-up view of the back side of the wearable navigation glove 150 shown in FIG. 1. The navigation display component 160 is shown inserted into a see-through pocket 170 positioned on the back side of the glove 150. As stated above, the navigation display component 160 synchronizes with the navigation software application on the navigation control device 175. Preferably, the navigation display component 160 includes an LED arrangement 180 that instructs the rider which way to turn based on the navigation information obtained from the synchronized navigation software application. Putting the LED or light arrangement 180 on the back of the glove 150 allows a motorcyclist to use and view the navigation prompts and information while riding and without requiring the user to remove his grip on the handlebars. A watch or other garment or accessory does not provide such ease of use since, for example, a watch requires the user to twist his wrist to view the display or pull up his jacket sleeve.

Preferably, the pocket 170 on the back of the glove is accessible to enable the navigation display component 160 to be inserted or removed, as necessary. The pocket 170 preferably has one or more see-through windows to enable the entire LED arrangement 180 to be visible therethrough. The LED arrangement 180 can be in any suitable form, such as a circle of LEDs (as shown in FIG. 2), a row of LEDs, a grid of LEDs, or different combinations of the above, some of which will be described in greater detail hereinafter.

FIG. 3 illustrates a close-up view of the palm side of the wearable navigation glove 150 shown in FIG. 1. Electronic switches 310, 320, 330, 340, and 350 are preferably integrated into the finger tip and thumb tip portions of the glove 150 to enable the user to switch the navigation system 100 on and off and to switch or toggle between different navigation functions by touching one or more selected fingertips to the thumb tip without requiring the user to remove his glove hand from the handlebars while riding. Preferably, conductive thread having a clip attachment are sewn or glued inside the lining of the glove 150 and run from the navigation display component 160 along and to each fingertip of the glove 150.

Providing a notification pattern or visual cue on the LED arrangement 180 to get the attention of the rider before providing navigation prompts or information minimizes distractions and unnecessary duplication of views toward the LED arrangement and reduces the risk that important information is missed each time it is sent to the glove.

Having discrete light patterns that indicate turn directions, proximity to the next navigation event, compass information, altitude, and other navigation information allows a user to obtain necessary or desired navigation information without having to view an actual display screen or map while riding and without having to pull over and access the rider's mobile device. Such light patterns are preferably pre-set by default but can also be customized by the user, if desired. Such animation light patterns make navigation directions more clear and easy to determine with less distraction to the rider.

For example, the LED arrangement 180 preferably includes an initial “notification” light pattern to let the rider know that the next navigation event and turn directions (e.g., continue straight, veer right or left, turn right or left, or make a U-turn, etc.) are about to be provided. In addition, the LED arrangement 180 preferably includes light patterns that provide distance information to the next navigation event. For example, the number of LEDs that light up when distance information is being provided can indicate distances to the next navigation event. Such distances can be provided on a linear scale (e.g., each LED indicating 0.5 miles) or on an exponential scale (e.g., 1-2 LEDs indicating a range under a few hundred feet while the maximum number of LEDs can indicate a range in excess of X number of miles). Alternatively (or in combination with the number of LEDs that light up), flashing lights of different speeds or rates or in different, selected light patterns can be used to indicate the proximity to the next navigation event. For example, the LEDs can begin to blink faster and faster, until they remain in an “on” state, as the rider approaches the next navigation event that requires an action. In addition, different colored lights can be used to provide different information. For example, green lights could be used to indicate that the rider is on the correct route, yellow lights could indicate that a navigation event is coming up, and red lights could indicate that the navigation event has arrived or been passed. But, again, the options for how colors, light brightness, blinking or flashing effects, etc. are used are infinite and, preferably, can be customized by the user based on the user's preferences.

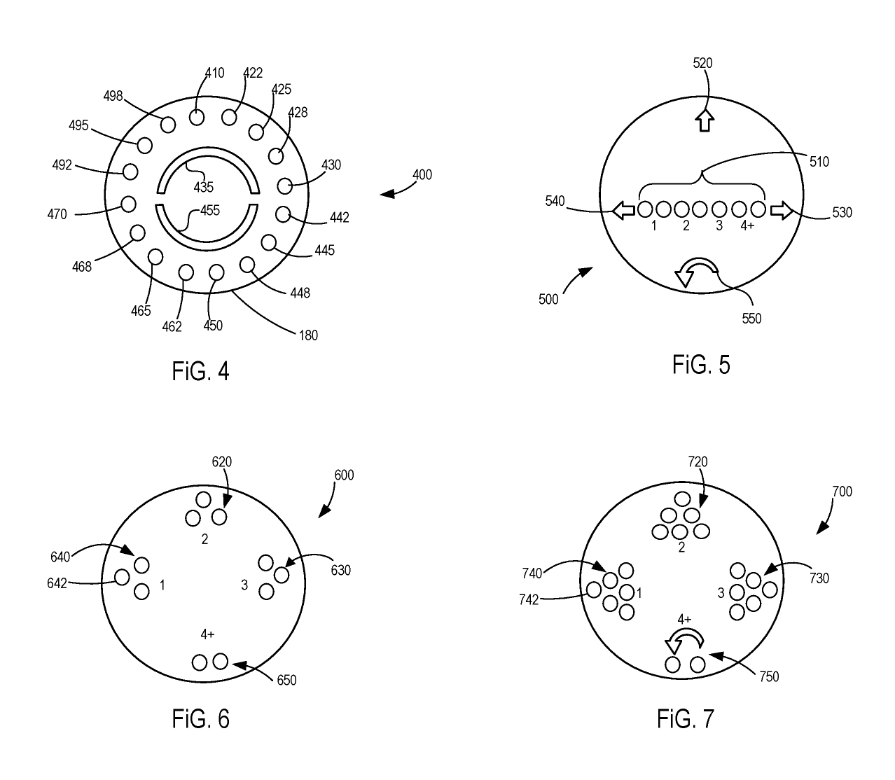

Several specific examples of LED prompts are described hereinafter—for illustrative purposes only. As stated above, the LED arrangement 180 preferably includes an initial “notification” light pattern to let the rider know that the next navigation event and turn directions are about to be provided. An initial notification light pattern can be any pre-arranged lighting of the plurality of lights on the LED arrangement 180. A preferred light arrangement 400 of the LED arrangement 180 is illustrated in FIG. 4. As shown, the preferred light arrangement 400 includes a plurality of LEDs, with LED 410 at the noon position, LED 430 at the 3 o'clock position, LED 450 at the 6 o'clock position, and LED 470 at the 9 o'clock position. Two central, circular lights 435, 455 are optionally included within the circle formed by the LEDs. These central, circular lights can be lit up to help attract the attention of the rider as part of the “notification” light pattern or they can be used in conjunction with any of the other navigation functions described herein. LEDs 422, 425, 428 are positioned in clockwise order between LEDs 410 and 430. LEDs 442, 445, 448 are positioned in clockwise order between LEDs 430 and 450. LEDs 462, 465, 468 are positioned in clockwise order between LEDs 450 and 470. LEDs 492, 495, 498 are positioned in clockwise order between LEDs 470 and 410.

In one embodiment, a “go straight” sequence is indicated, after the initial “notification” light pattern, with LED 450 lit opposite the lighting of five LEDs 410, 498, 422, 495, and 425. The five LEDs are then reduced to three LEDs 410, 498, and 422, and then by a single LED 410. Preferably, LED 450 is lit more dimly than the lights at the top or noon position. In some embodiments, if colored lighting is available, the top five lights would be lit in green rather than white.

A “go left” sequence can be similarly displayed, after the initial “notification” light pattern, with LED 430 lit opposite the lighting of five LEDs 470, 468, 492, 465, and 495. The five LEDs are then reduced to three LEDs 470, 468, and 492, and then by a single LED 470. Preferably, LED 430 is lit more dimly than the lights at the left or 9 o'clock position. Colored lights are again, optionally, used.

A “go right” sequence can be similarly displayed, after the initial “notification” light pattern, with LED 470 lit opposite the lighting of five LEDs 430, 428, 442, 425, and 445. The five LEDs are then reduced to three LEDs 430, 428, and 442, and then by a single LED 430. Preferably, LED 470 is lit more dimly than the lights at the right or 3 o'clock position. Colored lights are again, optionally, used.

A “U turn” sequence can also be displayed, after the initial “notification” light pattern, with LED 450 lit brightly in an “on” or “blinking” pattern. A plurality of (from three to five) LEDs 410, 498, 496 (and optionally 422, 425) are initially lit and then sequenced in counter-clockwise pattern around to the brightly lit LED 450. Preferably, as one new LED is lit in counter-clockwise sequence, the furthest LED in the clockwise position is turned off. The LEDs rotate toward the LED 450. The rotating lights indicate the direction of the U-turn.

Turning back to FIG. 3, touching of specific switches are used to activate different functions of the preferred navigation system 100. Specifically, thumb switch 310 can be touched in a single or double tap with any of the fingertip switches 320, 330, 340, and 350 to activate different predefined functions. For example, a double tap between thumb switch 310 and index finger switch 320 can be used to toggle the preferred navigation system 100 on and off. A single tap between thumb switch 310 and index finger switch 320 can be used to request that the navigation display component 160 indicate the distance to the next navigation event. For example, as shown in FIG. 4, a sequence of LEDs displayed, in clockwise order, starting with LED 470 and extending around the LED arrangement can be used to indicate the distance to the next navigation event. Each LED can be used to represent a specific distance in a linear fashion (e.g., each LED representing 0.5 mile increments, or each LED can be used to represent an exponentially further distance. Alternatively, distance can be represented by the brightness of the LEDs, the color of the LEDs, a blinking pattern represented by the LEDs, or some combination of one or more of the above.

Additionally, thumb switch 310 can be touched in a single or double tap with a different fingertip switch, such as pinky switch 350, to activate other predefined functions. For example, a single tap between thumb switch 310 and pinky finger switch 350 can be used to request that the navigation display component 160 display a compass, with true north being indicated by a lit LED. A double tap between thumb switch 310 and pinky finger switch 350 can be used to request that the navigation display component 160 display the current altitude. As shown in FIG. 4, a sequence of LEDs displayed, in clockwise order, starting with LED 470 and extending around the LED arrangement can be used to indicate the altitude. Each LED can be used to represent a specific distance (e.g., 1000 ft. increments, in a linear fashion or each LED can be used to represent an exponentially further distance).

Additionally, thumb switch 310 can be touched in a single or double tap with middle finger switch 330 or ring finger switch 340 to interact with an application running on the navigation control device 175, such as a music playback application. A single tap with middle finger switch 330 can be used to advance to the next song playing on the device; a double tap can be used to advance a predetermined number of seconds within the current song. Similarly, single tap with ring finger switch 340 can be used to skip back to the previous song prior to the one playing on the device; a double tap can be used to rewind a predetermined number of seconds within the current song.

Alternative LED arrangement configurations are illustrated in FIGS. 5-7. For example, LED arrangement 500 of FIG. 5 provides a simple LED scale 510, which can be used to indicate distance, range, or altitude, or the like. The scale can be linear or exponential, as described above. This LED arrangement 500 includes directional LED arrows, with LED 520 indicate north or straight ahead, with LED 530 indicating right turn, with LED 540 indicating left turn, and with LED 550 indicating a U-turn.

FIG. 6 illustrates an LED arrangement 600 in which the directions are illustrated by a triangle of 3 LEDs, with LED 620 indicating north or straight ahead, with LED 630 indicating right turn, with LED 640 indicating left turn, and with LED 650 indicating a U-turn. Scale can be indicated by the number of LEDs lit and by how far the LEDs are lit from the starting point LED, such as the outermost LED 642 at the none o'clock position.

FIG. 7 illustrates an LED arrangement 700, which is similar to the LED arrangement 600 from FIG. 6; however, the directions are illustrated by a triangle of 6 LEDs, with LED 720 indicating north or straight ahead, with LED 730 indicating right turn, with LED 740 indicating left turn, and with LED 750 indicating a U-turn. Scale can again be indicated by the number of LEDs lit (or rows of LEDs lit) and by how far the LEDs are lit in clockwise fashion around the LED arrangement from the starting point LED, such as the outermost LED 742 at the none o'clock position.

In view of the foregoing detailed description of preferred embodiments of the present invention, it readily will be understood by those persons skilled in the art that the present invention is susceptible to broad utility and application. While various aspects have been described herein, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A wearable navigation interface device comprising:
a processor;
a wireless communication component;
an LED display arrangement; and
memory having software code stored therein, the software code including instructions executable by the processor that causes the wearable navigation interface device:
to establish wireless communication using the wireless communication component with a navigation control device, the navigation control device having a navigation software application installed thereon, the navigation control device and the navigation software application being configured to determine a current geographic location of the navigation control device and to determine a route from the current geographic location to a desired destination identified by a user of the navigation control device, the route including a plurality of turning points between the current geographic location and the desired destination;
to receive navigation information from the navigation control device, the navigation information including the current geographic location, a current compass orientation of the wearable navigation interface device, a direction in which the user should go to reach a next of the plurality of turning points, and a distance from the current geographic location to the next of the plurality of turning points; and
based on the received navigation information, first to provide a notification to the user using a notification light pattern on the LED display arrangement and, thereafter, to provide the direction in which the user should go to reach the next of the plurality of turning points using a directional light pattern on the LED display arrangement.

2. The device of claim 1 wherein the navigation control device is integrated into a back side of a glove of the user.

3. The device of claim 2 wherein the navigation control device is sewn into lining of the glove.

4. The device of claim 2 wherein the navigation control device is inserted into a see-through pocket on the back side of the glove.

5. The device of claim 2 wherein the navigation control device further includes contact switches positioned in two or more fingertips of the glove.

6. The device of claim 5 wherein a predefined contact between two of the contact switches activates a predetermined function of the software code.

7. The device of claim 6 wherein the predetermined function of the software code includes one or more of: turning on or off the wearable navigation interface device, requesting navigation information from the navigation control device, sending instructions to the navigation control device, and displaying one or more of the navigation information.

8. The device of claim 6 wherein the predefined contact between two of the contact switches is made by a single tap, a double tap, or a sustained touching.

9. The device of claim 1 wherein the navigation information further includes a current altitude of the wearable navigation interface device.

10. The device of claim 9 wherein the instructions executable by the processor further cause the wearable navigation interface device to provide the current altitude of the wearable navigation interface device using an altitude light pattern on the LED display arrangement.

11. The device of claim 1 wherein the instructions executable by the processor further cause the wearable navigation interface device to provide the distance from the current geographic location to the next of the plurality of turning points using a distance light pattern on the LED display arrangement.

12. The device of claim 1 wherein the instructions executable by the processor further cause the wearable navigation interface device to provide the current compass orientation of the wearable navigation interface device using a compass light pattern on the LED display arrangement.

13. The device of claim 1 wherein the LED arrangement include a plurality of LEDs.

14. The device of claim 13 wherein the plurality of LEDs are arranged in a circular pattern.

15. The device of claim 13 wherein the plurality of LEDs are arranged in a linear pattern.

16. The device of claim 13 wherein the plurality of LEDs are arranged in discrete groups on a top surface of the LED arrangement.

17. The device of claim 13 wherein the LEDs provide light patterns using one or more of: a single color of light, a plurality of colors of light, and a sequence of blinking lights.
